(19) United States
(12) Patent Application Publication
(10) Pub. No.: US 2021/0141940 A1
(43) Pub. Date: May 13, 2021

(54) METHOD AND SYSTEM FOR ENHANCING THE INTEGRITY OF COMPUTING WITH SHARED DATA AND ALGORITHMS

(71) Applicant: sensoriant, inc., cedar knolls, NJ (US)

(72) Inventors: Shamim A. Naqvi, Morristown, NJ (US); Robert Frank Raucci, New York, NY (US); Goutham Puppala, Basking Ridge, NJ (US)

(21) Appl. No.: 17/094,118

(22) Filed: Nov. 10, 2020

Related U.S. Application Data
(60) Provisional application No. 62/934,691, filed on Nov. 13, 2019.

(51) Int. Cl. G06F 21/64; G06F 21/60; H04L 9/08; H04L 9/30; H04L 9/32

(52) U.S. Cl. CPC G06F 21/64; G06F 21/602; H04L 9/321; H04L 9/3073; H04L 9/0894

(57) ABSTRACT

A method for providing a secure computing environment creates an isolated computing environment using supervisory programs that are provided with a public access key of a public-private access key pair and not the private key of the public-private access key pair such that access to the computing environment is unavailable to the supervisory programs to thereby prevent the supervisory programs from affecting results of computations executed in the computing environment. An isolated computing environment is a computing environment in which only a specified maximum number of application processes and specified system processes implementing the computing environment are able to operate. A baseline digest of the isolated computing environment is caused to be generated and stored in a location so that the baseline digest is validated by or available to at least one third party to thereby establish a trusted and isolated computing environment.

### CROSS-REFERENCE TO RELATED APPLICATIONS

This application claims the benefit of U.S. Provisional Application Ser. No. 62/934,691, filed Nov. 13, 2019, the contents of which are incorporated herein by reference.

### FIELD OF THE INVENTION

The present invention relates generally to maintaining the integrity of computations, i.e., the activity, during which algorithms operate on data. The computations considered generally, but not exclusively, belong to cases in which the data and algorithms are provided, i.e., shared, by 3^{rd} party providers and in which the resulting outputs may be provided to one or more pre-determined and possibly authorized parties.

### BACKGROUND

The Internet/web supports an enormous number of devices that have the ability to collect data about consumers, their habits, actions, activities, and their surrounding environments. Innumerable applications utilize such collected data to customize services and offerings, glean important trends, predict patterns, and train classifiers and pattern-matching computer programs. An important and burgeoning area of recent activity is that of crowd-sourced data applications wherein data is collected from consumer devices in near real-time and processed to derive patterns, e.g., predict routes with less traffic, monitor consumer's health, etc.

Many enterprises collect data from consumers, e.g., medical institutions collect data from patients and test subjects, financial institutions collect or come into possession of consumer's financial data, retailers collect data about the buying habits of consumers, and Internet services providers collect data about consumer's subjects of interest.

Once refined, aggregated and tabulated, such datasets become enormously valuable for purposes of data analysis, e.g., discovering new drugs, or devising new therapies for diseases. It would be of great commercial benefit to enterprises to allow their datasets to be analyzed by third parties, provided the integrity and ownership of the data is maintained.

Recent advances in machine learning technology and data mining have led to the development of powerful algorithms that can analyze datasets and extract useful information. Thus, pharmaceutical companies have used algorithms to mine datasets to discover new drugs and treatments, financial institutions have mined datasets to detect credit card usage patterns and fraud detection, Internet service providers deliver targeted advertisements based on detecting user interest, etc.

It is well-known and generally accepted that the value of insights obtained from a dataset grows with its size. Therefore, many enterprises are interested in acquiring multiple datasets from third parties for analytical purposes.

There is thus value that can be derived from creating computing technology that allows the analysis of third party datasets by algorithms in a manner that protects the ownership and security of both, and preserves the privacy of an individual's data, e.g., personally identifiable information of patient data. Additionally, such computing technology may be useful to enterprises to satisfy a growing list of regulations such as Health Insurance Portability and Accountability Act of 1996 (HIPAA), General Data Privacy Requirements (GDPR), Payment Services Directive number 2 from the European Union, California Consumer Privacy Act (CCPA), etc.

It would be advantageous therefore to enhance the integrity of computations by ensuring that no external entity may copy or steal the algorithm or the data, and that the outputs of computations are directed only to pre-specified recipients. Furthermore, outputs generated by computations should be able to be verified as having been the result of the execution of a specific algorithm operating on specific dataset(s). Thus, the provenance of the results can be ascertained.

### SUMMARY

In accordance with one aspect of the systems and techniques described herein, a method is provided for maintaining the integrity of a data processing system. In accordance with the method, a policy data structure is created containing at least one policy that is based at least in part on information provided by an algorithm provider and a data provider. The algorithm provider provides at least one algorithm that is to be executed on at least one dataset provided by the data provider. The policy data structure is created by policy manager logic operating in a first trusted and isolated computing environment. A trusted computing environment is a computing environment whose computer code is able to be attested by comparing a digest of computing environment to a baseline digest of the computing environment that is available to third parties to thereby verify computing environment integrity. An isolated computing environment is a computing environment in which only a specified maximum number of application processes and specified system processes implementing the computing environment are able to operate. The policy manager logic causes creation of a second trusted and isolated computing environment. Responsive to a request from the second computing environment, the policy data structure is sent to the second computing environment. In accordance with the policy, the algorithm and the dataset are received from the algorithm provider and the data provider, respectively, in the second computing environment. In accordance with the policy, one or more decryption keys are obtained for decrypting the encrypted algorithm and the encrypted dataset and the encrypted algorithm and the encrypted dataset are decrypted using one or more decryption keys. The decrypted algorithm and the decrypted dataset are caused to be input into a digest generating environment (DGE) operating in the second computing environment. The DGE is configured to provide a digest of the decrypted algorithm and an algorithm output from executing the decrypted algorithm on the decrypted dataset. In accordance with the policy, the digest of the decrypted algorithm and an algorithm output arising from execution of the decrypted algorithm on the decrypted dataset in the DGE are encrypted. The encrypted digest and the encrypted algorithm output are sent from the second computing environment to an output data store specified by the policy.

In accordance with another aspect, the one or more decryption keys for decrypting the encrypted algorithm and the encrypted dataset are obtained from the policy manager logic or the algorithm provider and the dataset provider, respectively.

In accordance with another aspect, encrypting the digest of the encrypted algorithm and the algorithm output arising from execution of the decrypted algorithm on the decrypted dataset is performed using an encryption key obtained from the policy manager logic.

In accordance with another aspect, the key encrypting the digest of the encrypted algorithm and the algorithm output is stored in a hardware security module included in a hardware computing arrangement in which the second computing environment is created.

In accordance with another aspect, the computing environment is created in a hardware computing arrangement that includes a plurality of computing machines.

In accordance with another aspect, the encryption keys encrypting the algorithm and the dataset are provided to the algorithm provider and the dataset provider by a key vault associated with the second trusted and isolated computing environment in response to receipt of pre-established account credentials from the algorithm provider and the dataset provider.

In accordance with another aspect, creation of the second trusted and isolated computing environment includes creating an isolated computing environment in isolated memory using supervisory programs that are provided with a public access key of a public-private access key pair and not the private key of the public-private access key pair such that access to the computing environment is unavailable to the supervisory programs to thereby prevent the supervisory programs from affecting results of computations executed in the computing environment.

In accordance with another aspect, the public access key is provided to the supervisory programs by the policy manager logic.

In accordance with another aspect, the policy manager logic provides a decryption key for decrypting the encrypted algorithm output to a designated recipient after the designated recipient is authorized using pre-established account credentials.

In accordance with yet another aspect of the systems and techniques described herein, a method is provided for providing a secure computing environment. In accordance with the method, an isolated computing environment is created using supervisory programs that are provided with a public access key of a public-private access key pair and not the private key of the public-private access key pair such that access to the computing environment is unavailable to the supervisory programs to thereby prevent the supervisory programs from affecting results of computations executed in the computing environment. An isolated computing environment is a computing environment in which only a specified maximum number of application processes and specified system processes implementing the computing environment are able to operate. A baseline digest of the isolated computing environment is caused to be generated and stored in a location so that the baseline digest is validated by or available to at least one third party to thereby establish a trusted and isolated computing environment.

In accordance with another aspect, policy manager logic causes creation of the isolated and trusted computing environment. The policy manager logic provides a policy data structure to the isolated and trusted computing environment. The algorithm provider provides at least one algorithm that is to be executed on at least one dataset provided by the data provider. The policy data structure specifies one or more policies concerning processes to be followed and/or parameters to be used to execute the algorithm on the at least one dataset in the isolated and trusted computing environment.

In accordance with another aspect, the one or more policies are based at least in part on information provided by the algorithm provider and the data provider

In accordance with another aspect, the one or more policies specify that the algorithm and the dataset are to be provided access to the isolated and trusted computing environment and further comprising receiving in the isolated and trusted computing environment the algorithm and the dataset in encrypted form.

In accordance with another aspect, the algorithm provider and the dataset provider encrypt the algorithm and the dataset, respectively, using a private key that is provided by a key vault associated with the isolated and trusted computing environment in response to receipt of pre-established account credentials from the algorithm provider and the dataset provider.

In accordance with another aspect, and in accordance with the one or more policies, one or more decryption keys are obtained for decrypting the encrypted algorithm and the encrypted dataset and decrypting the encrypted algorithm and the encrypted dataset.

In accordance with another aspect, the encryption keys are provided by a key vault associated with the trusted and isolated computing environment in response to receipt of pre-established account credentials from the algorithm provider and the dataset provider.

In accordance with another aspect, the private keys that encrypt the algorithm and the dataset are used as the decryption keys.

In accordance with another aspect, the decrypted algorithm and the decrypted dataset are caused to be input into a digest generating environment (DGE) operating in the computing environment. The DGE is configured to provide a digest of the decrypted algorithm and an algorithm output from executing the decrypted algorithm on the decrypted dataset.

In accordance with another aspect, and in accordance with the one or more policies, encrypting the digest of the decrypted algorithm and an algorithm output arising from execution of the decrypted algorithm on the decrypted dataset in the DGE are encrypted the encrypted digest and the encrypted algorithm output are sent from the second computing environment to an output data store specified by the policy.

In accordance with another aspect, the digest of the decrypted algorithm and the algorithm output are encrypted using an encryption key provided by the policy manager logic.

In accordance with another aspect, the policy manager logic provides a decryption key for decrypting the encrypted algorithm output to a designated recipient after the designated recipient is authorized using pre-established account credentials.

In accordance with another aspect, creating the isolated computing environment includes creating the isolated computing environment in isolated memory.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1A depicts a sharing policy between an Algorithm Provider and a Data provider.

FIG. 1B shows an example of a policy stored in a data structure.

FIG. 2 depicts a method for deriving the output of a policy directed computation.

FIG. 3 shows the various entities and components use by a Data Processing Engine (DPE) to implement a simple policy directed computation.

FIG. 4 shows a method for implementing a simple policy directed computation using the DPE shown in FIG. 3.

FIG. 5 shows a method for protecting an algorithm that is be executed in a computing environment as part of a policy directed computation

FIG. 6 shows the components of one example of a computing environment created in one or more computing entities.

FIG. 7 shows a method for establishing a trusted computing environment from the computing environment shown in FIG. 6.

FIG. 8 shows one example of a Trusted Data Processing Engine (TDPE) for use in executing a general policy directed computation.

FIGS. 9-11 show one example of a method by which a secure policy directed computation is performed using the TDPE shown in FIG. 8.

FIG. 12 shows an example of a pipelined policy directed computation.

FIG. 13 shows a comparison between the data handling properties of two computing environments.

FIG. 14 shows a pictorial representation of the working of a Digest Generating Environment (DGE).

FIG. 15 shows an arrangement wherein computer processes may be embedded within other computer processes.

### DETAILED DESCRIPTION

### Motivation

Mobile computing devices such as smart phones, personal digital assistants, fitness monitoring devices, smart watches, etc., contain multiple sensors to monitor and collect data on the actions, environment, surroundings, homes, activity and health status of users. Consumers routinely download hundreds of apps onto their mobile devices and use these apps during their daily lives. Many such apps collect data and make it available to powerful servers for processing. It is thus possible to derive the health state of individuals, their personal details, home conditions, family information, buying and purchasing habits and preferences, etc. The utility and power of such technologies is undeniable and obvious.

Many consumers find such practices to be intrusive of their privacy and demands are growing for privacy regulations, restrictions on data collection and even outright curtailing of data collection and regulating enterprises.

Certain regulations have been enacted in recent years to protect user privacy, salient amongst which are HIPAA (Health Insurance Portability and Accountability Act 1996), GDPR (General Data Protection Regulations), PSD2 (Revised Payment Services Directive of the European Union), CCPA (California Consumer Privacy Act 2018), etc.

As used herein, the term “user information” includes but is not limited to what is generally referred to in the literature as PII (Personally Identifiable Information) or PHII (Personal Health Identifiable Information).

Concomitantly, algorithm development is an expensive and time-consuming intellectual endeavor and practitioners prefer to protect their investment by keeping their algorithms secure and protected. These algorithms need to operate on data. The insights extracted by an algorithm grow with the size of the dataset available to it for processing. There is thus a need to provide computing facilities that allow 3^{rd} party algorithms to operate on shared datasets wherein each party, i.e., the data and algorithm provider, are assured of security of their individual assets.

### Brief Review of Existing Approaches

Regulations and a growing sentiment in the user community is creating a desire in enterprises to find technological solutions to the problem of allowing privacy preserving computations over datasets containing user data. For example, mobile phone operating systems typically require a user to authorize access to private data, e.g., location data. Such requests may become burdensome if consumers are repeatedly required to authorize access to their private data. Recently, a mobile phone manufacturer has announced restrictions on the mechanism by which user location data is provided to third-party application developers, but its own apps do not require such authorizations, thusly creating an imbalanced marketplace.

Another mobile operating system provider has announced a software library to control third-party inquiries that can be processed against datasets containing user data. This technology, referred to as differential privacy, attempts to maintain user data privacy by restricting the power of query languages, e.g., by allowing only aggregate inquiries such as computing the total salary of a group of employees, but disallows computing a particular individual's salary. It is well-known that such constraints are too restrictive and severely limit the kinds of analysis that enterprises wish to perform. It is also known that a sequence of aggregate queries (with successively narrowing scope) can in principle be designed to glean information about specific individuals.

Computer science literature describes another approach based on a type of encryption technology (called homomorphic encryption). Processing techniques are then known that allow computations to be performed on homomorphically encrypted datasets (ciphertext) without violating user data privacy. However, the computational cost in resources and speed of processing is severely impacted and makes this approach a practical impossibility.

In yet another mathematical approach, called multiparty computation (MPC), a group of networked nodes engage in a collective computation (by exchanging messages) in which each node knows only its own data and, at the conclusion of the computation, knows at most the final result of the computation. For example, in a group of nodes, each node may represent and know the net worth of its corresponding owner. The group may then engage in a multiparty computation that determines the richest owner without any node becoming aware of the personal net worth of any other owner. MPC algorithms suffer from computational inefficiencies in time, space, and number of networking messages, i.e., communication load.

In one aspect the present invention enhances the integrity of computations, i.e., the activity during which algorithms operate on data, ensuring that no external entity may copy the algorithm or the data, and that the outputs can be verified as being produced by the specified algorithm. We show methods by which cryptographic data, needed to ensure integrity of computations, is generated within and transmitted only between computational entities, e.g., computing environments, that can be verified to be free of malware and other intrusive software, i.e., processes.

### Policy Directed Computations

We define a computing entity as an actor that has a domain whose elements are called resources. An actor may perform actions on its resources, i.e., actions are side-effects that change the state of resources. For example, an actor A may have a finite domain of resources dom(A)={d₁, d₂, . . . , dₙ} where the elements dᵢ may refer to individual datasets. An action is a mapping from the domain of actors to the domain of resources. For example, if element e ∈ dom(A) then action ∝: A(e)→B=dom(B) ∪ e. That is, actor A's action ∝ assigns its resource e to the actor B. We may refer to ∝ as a resource assignment action. An actor may assign a resource to multiple actors, i.e., specify multiple (resource assignment) actions that assign the same resource to different actors.

Many different kinds of actions other than resource assignment actions may be defined. For example, we may define a resource deletion action as follows. β: A( [symbol] e)→B=dom(B)−{e} specifies an action that removes resource e from the domain of B. Expressions such as dom(B)−{e} will be called the side-effect of an action.

A time period t may be associated with an action. Thus, ∝: A(e)→B[t] associates time period t with the policy ∝. In the present exposition all time periods refer to a global clock available to the computational system being described herein.

We assume that the collection of actors contains a privileged actor called the Policy Manager. It has a pre-determined and provisioned action called executePolicy detailed below. Other pre-determined and provisioned actions of the Policy Manager will be described later.

A policy is a finite collection of actions {∝₁, ∝₂, . . . } for a given collection of actors. A policy is said to be executed if all its actions have been carried out by the privileged actor, the Policy Manager, i.e., the Policy Manager applies its executePolicy action to every element of the policy. The union of all domains of all actors is called the (domain of) resources of the Policy Manager. By definition, the Policy Manager has a privileged resource in its domain called the output, o. We define the collection of actors to contain an additional privileged actor called the Operator which has a pre-determined and provisioned action called executePolicyManager.

Consider, by way of example, an enterprise Hospital A that has a resource, dataset d₁, and an enterprise B that has a resource, Algorithm a₁. Then a resource assignment action from actor A may specify that the dataset d₁ may be assigned to actor B, and another action may specify that resource a₁ be assigned to actor A. Furthermore, the output resource of the Policy Manager is to be assigned to the entity, Output Recipient. The entity Operator has an empty resource domain and is not the target of any resource assignment actions.

In other words, we may define a policy P in which Hospital A assigns its dataset d₁ for processing by algorithm a₁ to enterprise B. Furthermore, the Operator is not allowed access to the dataset or the algorithm. The Policy Manager is to execute said policy which directs the output of the Policy Manager to the entity, Output Recipient. The policy P may be represented using our terminology as follows.
dom(A)={d₁}
dom(B)={a₁}
dom(Operator)={ }
dom(PolicyManager)={a₁, d₁, o}
dom(OutputRecipient)={ }
action ∝: A→B=dom(B) ∪ {d₁}
action β: B→A=dom(A) ∪ {a₁}
action executePolicy: PolicyManager→OutputRecipient=dom(OutputRecipient) ∪ o

FIG. 1A shows a pictorial representation of the above policy. The entities 101, 102, 103, 104 and 105 represent the actors Hospital A, enterprise B, Operator, Output Recipient, and Policy Manager. Hospital A assigns its resource d₁ to Enterprise B's algorithm a₁ through action 106. Action 107 assigns algorithm a₁ to dataset d₁. Action 108 of the Policy Manager 105 assigns its output resource o to Output Recipient 104 and action 109 represents the executePolicyManager action of the Operator 103. Policy Manager 105 contains the policy P representing the collection of actions 106, 107, 108 and 109.

FIG. 1B shows an example of a policy. A policy consists of information obtained from or provided by entities such as Data Provider, Algorithm Provider, etc., or generated by other computer programs such as the Policy Manager 105 (cf. FIG. 1A). We represent policy information as a tabular data structure. Many other types of data structures may be used, e.g., comma separated values, etc.

Each row of the tabular data structure represents one policy. In the first row of FIG. 1B policy number 123 represents some of the information provided by Data Provider Hospital A and Algorithm Provider Company XYX. The location of Hospital A's dataset is given by URL-1 from where it can be retrieved. The columns “public key” and “private key” are examples of informational elements generated by the Policy Manager 105 (cf. FIG. 1A); such elements will be described in detail later, as will other informational elements of policies not shown in FIG. 1B.

In descriptions here and in the following we refer to information collected from entities such as the Data Provider, etc. One way to collect such information is for the Operator to construct a data portal, e.g., a web page, at a well-known IP address. An entity, e.g., Data Provider, may then access the portal and enter information about its dataset, e.g., URL of its dataset, through a web page interface. Similarly, other entities such as Algorithm Provider can also access the portal and enter Algorithm related information, e.g., URL of its algorithm.

Note that not all the information shown in FIG. 1B will come from the Data and Algorithm Providers. For example, the element of the policy called Private/Secret Key will not be known to either the Data Provider or the Algorithm Provider. The Data and Algorithm Providers may use the portal to enter the information they know, e.g., complete the web page. Once all the information has been provided and the online form has been completed, it may be processed by portal logic and provided to another computer program, e.g., the Policy Manager 105 of FIG. 1A. The latter may then receive the information and construct a data structure as shown in FIG. 1B, filling in the remaining information such as the private and public keys.

In some of the descriptions of methods described below we use terms such as a provisioning process, an out-of-band process, an initialization process, etc. These terms include the possible use of web portals and web interfaces to collect information from various entities.

A policy directed computation is the execution of an algorithm on one or more input datasets wherein the execution is subject to the executePolicyManager action of the Operator.

It is instructive to further consider the notion of actions described above with particular respect to the notion of assigning resources to actors under the above-mentioned constraints.

The general field of cryptology pertains to keeping data safe from intrusive software or unauthorized entities. One technology used to assure the safety of data is that of encryption and decryption functions. An encryption function may be thought of as a technique of “blinding” data so that it appears to be seemingly random. The corresponding “unblinding” function of obtaining the original data is called decryption. Relevant literature also uses the terms ciphertext and cleartext as the result of encryption and decryption functions when applied to an inputted data item.

Several encryption functions are known in the literature, e.g., National Institute of Standards (NIST) provides the family of SHA functions. No efficient methods are known for breaking the encryption keys based on these functions. In this sense, these and other such known functions are said to be secure. (Essentially, only brute force methods are known to break encryption functions. If encryption keys are chosen to be of a suitable length, then brute force methods to break the encryption become computationally infeasible.)

Typically, to assure safety, data items may be encrypted while in storage (“encryption-at-rest”) or when being transmitted (“encryption-in-transit”). An encrypted data item may be inputted to a computer program for processing in which case we may refer to the situation as “encryption-in-use.” A computer program that receives encrypted data as input needs a decryption key to decrypt the data before it can proceed.

In the present exposition we use all three types of encryption technologies, i.e., encryption-at-rest, encryption-in-transit, and encryption-in-use. Therefore, all actions that assign a resource to an actor are assumed to be subject to these encryption technologies. One way of satisfying this requirement is to assume that all resources are encrypted and an action by which an (encrypted) resource is assigned by a first actor to a second actor entails “using” a decryption key.

For example, a dataset, i.e., a resource, may be encrypted by a first entity and stored in encrypted form in an Output Store, i.e., using encryption-at-rest. An action to assign the dataset to a second entity may entail providing a decryption key to that entity. Similarly, an encrypted dataset may be inputted, i.e., assigned, to an algorithm for a case using encryption-in-use. Finally, a dataset may be transmitted in encrypted form from one entity to another along a network connection, i.e., using encryption-in-transit, wherein the receiving entity needs a decryption key to validate what it has received.

Note that not all actions may entail the use of an encryption or decryption keys. For example, an entity may forward a received dataset, i.e., resource, without examining the resource. That is, the entity merely forwards what it has received, oblivious to whether the received object is encrypted or not. In such cases, the encryption may be considered irrelevant to the action.

As another example, a first entity A needs a key to encrypt its dataset. It may ask a second entity B to provide it such a key. Now two cases may be considered. In the first case, entity B sends the encryption key to A in its “native” form, i.e., as a sequence of bits or hexadecimal digits. Entity A receives the key and uses it to encrypt its dataset. This is an example wherein the resource being sent can be received and used without needing a decryption key. No encryption-in-transit technology is being use.

The above case may be considered unsafe since it exposes the encryption key during transmission, Thus, we may consider a second case. In the second case, B may encrypt the encryption key, encrypt(encryptionKey)=x and transmit x to A who now must first decrypt x before it can be used, i.e., decrypt(x)=encryptionKey.

In embodiments, causing all actions of actors to be subject to encryption technologies is a central tenet of the present invention. In particular, causing a decryption key to be securely provided (as detailed later) to an actor is a central tenet of the present invention. Further, establishing a trust model wherein the provisioning of keys to actors that need said keys (and only those actors that need said keys) can be verified is another tenet of the present invention.

If encryption technologies are assumed to provide security of data then policy directed computations can be said to be secure by definition (since there is no distinction between algorithms and data as far as digital computers are concerned, said distinction only being maintained by humans).

If encrypted data is assumed to preserve privacy of (user) data items (since it cannot be processed without a decryption key) and the action of provisioning of decryption keys is subject to encryption-in-use technology, then a policy directed computation using said decrypted data can be said to preserve the user's data privacy.

That is, the use of these three types of encryption technologies in some embodiments described herein will imply satisfaction of the requirements of user data privacy, security and trust.

For reasons of clarity and simplicity, a policy directed computation will first be described that does not employ the three types of encryption technologies discussed above. A subsequent discussion will describe a policy directed computation that does employ the three types of encryption technologies
Method: Policy Directed Computation without using the three types of encryption technologies above.
Provisioned Entities:
Output Recipient, Data Provider, Algorithm Provider, Operator, Policy Manager, Output Store.
Data Provider or Algorithm Provider designates Output Recipient as the entity that receives output of method.
Operator provisions a first computer (cluster), initializes the computer using a first initialization Script (described later), which loads the computer program Policy Manager.
Input: Dataset D1 provided by Data Provider, Algorithm A1 provided by Algorithm Provider, Designated Output Recipient.
Output: Output of method provided to Output Store; decryption key provided to Policy Manager.
   1. Operator initiates Policy Manager.
   2. Data Provider executes action requesting Policy Manager to provide it an encryption key to encrypt dataset D1 stored at a specified location given by a location identifier.
   3. Algorithm Provider executes action requesting Policy Manager to provide it an encryption key to encrypt Algorithm A1 given by a location identifier.
   4. Policy Manager creates and stores policy data structure (e.g., FIG. 1B).
   5. Operator executes action executePolicyManager. This causes a second computer cluster to be provisioned and initialized using a second Initialization Script (described later).
   6. Policy Manager executes action executePolicy. This causes a policy directed computation to be initiated (by the second initialization script) in the second computer (cluster). The output of the policy directed computation is stored in the Output Store.
   7. The output recipient is informed of the availability of the output at the Output Store.
   8. Output Recipient requests and receives decryption key from Policy Manager to decrypt output of policy directed computation.
   9. Output Recipient retrieves output from Output Store.

FIG. 2 is a message flow diagram depicting the above method.

In a provisioning step, the Data Provider or the Algorithm Provider designates an Output Recipient.

In step 1, the Operator initiates the Policy Manager.

In step 2, the Data Provider requests an encryption key from the Policy Manager to encrypt its dataset D located at a specific location.

In step 3, the Algorithm Provider requests an encryption key from the Policy Manager to encrypt its algorithm A1 located at a specific location.

In step 4, the Policy Manager, having generated the encryption (public) keys in step 2 and 3 above, generates the corresponding decryption (private) keys, translates the information received from the Data and Algorithm Providers and constructs a policy data structure (a lá FIG. 2), saves the private keys and saves the policy data structure for later use.

In step 5, the Operator executes the executePolicyManager action. This causes a second computer cluster to be provisioned and initialized using a second Initialization Script (described later).

In step 6, the Policy Manager executes the executePolicy action. This causes a policy directed computation to be initiated (by the second initialization script) in the second computer (cluster). Furthermore, the policy directed computation requests and receives an encryption key from the Policy Manager. Now, the output of the policy directed computation is encrypted using the received encryption key and stored in the Output Store.

In step 7, the Policy Manager informs the output recipient of the availability of the output at the output store.

In step 8, the Output Recipient requests and receives the decryption key from the Policy Manager.

In step 9, the output is retrieved by the Output Recipient which may use the received decryption key to decrypt the retrieved output.

A computation is a term describing the execution of a computer algorithm on one or more datasets. (In contrast, an algorithm or dataset that is stored, e.g., on a storage medium such as a disk, does not constitute a computation.) The term process is used in the literature on operating systems to denote the state of a computation and we use the term, process, to mean the same herein. A computing environment is a process created by software contained within the supervisory programs, e.g., the operating system of the computer (cluster), that is configured to represent and capture the state of computations, i.e., the execution of algorithms on data, and provide the resulting outputs to recipients as per its configured logic. The software logic that creates computing environments (processes) may utilize the services provided by certain hardware elements of the underlying computer (or cluster of computers). A Trusted Data Processing Engine (TDPE) is a particular kind of computing environment that supports policy directed computations.

(The term supervisory programs as used herein refers to computer programs that operate and manage the services provided by single computers, groups or networks of computers (referred to as clusters herein), or virtual machines, etc. The term generalizes operating systems, virtual machine monitors and other such software. Processes created by supervisory programs are sometimes called system processes, in contrast to processes created by application programs which are called application processes.)

All arrangements shown in the following descriptions showing individual computers and/or computer clusters may use either a single computing entity or a cluster of computing entities.

As used herein, a TDPE refers to a computing environment that enhances the integrity of computations by providing trust (a term described later), and by allowing the results of computations to be verified (as described later) as being the results obtained by the execution of a specified algorithm on a specified dataset, and by providing the resulting outputs to specified recipients. Furthermore, the integrity of computations is further enhanced by ensuring that the computing environments (equivalently, the processes that represent them) are isolated and, hence, free from the risk that their contents may be stolen by malware or by concurrently executing intrusive processes. The terms trust, isolation and verification are described in more detail later.

As is well-known in operating systems, processes may contain subprocesses that, in turn, may contain sub-sub processes, etc. FIG. 15-A shows an arrangement in which process 1 contains sub-process 2 which, in turn, contains sub-process 3. In an alternative arrangement (FIG. 15-B), process 1 may contain process 2 and process 3 as its sub-processes. We will have occasion to use arrangements in which computing environments, i.e., processes, are embedded within other environments.

Furthermore, a TDPE may be constructed and used once, or it may be made persistent and re-assembled multiple times at later instants. In the latter case, the state of the TDPE may be preserved and re-instantiated upon demand without any loss of continuity of trust, isolation and verification.

In the descriptions that follow, we use phrases such as “computing environment requests” or “computing environment receives” etc., as shorthand to mean that the software logic that creates the computing environment is configured to request and receive, etc. Further, we will describe in more detail later but mention here that the logic that creates computing environments may be invoked, i.e., triggered, either by commands issued by the boot logic of the computer or by an application level user script, e.g., installation script.

Implementation of TDPE

We now discuss the implementation of TDPEs by taking an incremental approach in which we first describe a simple solution that does not enforce the “encryption” requirements on all actions taken by the various actors in a TDPE system. This will not only highlight the importance of the encryption requirements, but also serve to clarify some of the salient aspects of the present invention.

FIG. 3 shows a functional block diagram of an example of a DPE, which unlike a TDPE, does not enforce the encryption-in-use, encryption-in-transit, and encryption-at-rest requirements. That is, the term DPE—Data Processing Engine—will be used to refer to data processing engines that do not use the full power of the three types of encryption technologies described above; more complete description of a TDPE are provided later.
The actors Data Provider, Algorithm Provider, Operator, Output Recipient and Policy Manager are represented by computer programs 301, 302, 303, 304 and 313, respectively.
Installation script 306 is a computer program that creates a computing environment 308 that can support Algorithm 309 and Data 310. Computing environment 308 is conventional in the sense that it has the capability to run Algorithm 308 on Data 309. Both the installation script 306 and the computing environment 308 are housed in one or more computers comprising a computer cluster 320. The computer cluster 320 is assumed to have supervisory programs 311 and various utilities and device drivers 305 available to it.
The Policy Manager 313 is implemented by a computer program 313. We assume that a computer program Audit Manager 314 records all actions taken by the various actors, i.e., computer programs. Both the Policy Manager 313 and the Audit Manager may be housed in a computer program called the Controller (312) which runs on a (cluster of) computers in network connection with the cluster 320.
The Output Store 315 is represented by a computer program 315 that is conventional in the sense that it receives output data and stores it for later retrieval. The received data is this instance is not encrypted, i.e., it is cleartext.

### General Description of the Operation of DPE

Given the DPE depicted in FIG. 3, we may describe its construction as follows (cf. FIG. 4). Note that FIG. 4 shows one way of implementing a DPE.

Step 1 is a provisioning step in which the network location identifiers, e.g., a Universal Resource Identifier (URI) or Universal Resource Locator (URL), of programs 301, 302, 303, 304 and 315 are communicated to the Operator.

In step 2, the Operator provisions a first computer cluster to establish controller 312, installs a first installation script and invokes the script. The invocation includes various location identifiers it received in step 1 above as parameters. The first installation script loads the Policy and Audit Manager programs 313 and 314.

In step 3, computer program 301 provides a network location identifier, to the location of its Algorithm to the program Policy Manager 313. It requests and receives an encryption key from the Policy Manager 313. Similarly, the program 302 provides a network location identifier to its dataset to the program Policy Manager 313 and receives a (different) encryption key. Either program 301 or 302 (or both) authorize the computer program 304 as the Output Recipient and provide a location identifier to the Data Store 315. Policy Manager 313 constructs a policy, P, from the information described above that it received from programs 301 and 302.

In step 4, Policy Manager 313 provisions a second computer cluster 320, installs installation script 306 in the cluster and provides its network location identifier to the Policy Manager 313. Program Policy Manager 313 invokes script 306 with the unique identifier, i.e., name or number of the policy, P, as a parameter. Installation script 306 issues command to create computing environment 308 in the second computer cluster 320.

In step 5, computing environment 308 requests and receives (certain elements of) the policy P from the Policy Manager 313. (A protocol determines which elements of the policy are provided by the Policy Manager upon request by a computing environment and what authentication measures are to be satisfied by such requests.) Computing environment 308 requests and receives Algorithm 309 and Data 310 from programs 301 and 302, respectively. Computing environment requests and receives decryption keys from the Policy Manager 313. Computing environment 308 initiates execution of Algorithm 309 on data 310 and provides the ensuing output to Output Store 315.

In step 6, the computing environment 308 informs Output Recipient 304 of the availability of the output.

In step 7, the audit log obtained by the audit manager 314 records all actions taken by the various programs is made available to the Operator and to any other requesting actor.

### Shortcomings of the Implementation of the DPE

Isolation: Computer malware is a big problem in today's computer systems. Malicious computer programs continue to be injected into computer systems where they snoop on concurrently executing (authorized) programs and steal data, such as passwords, credentials, keys, and records. Such malicious programs may copy, alter or corrupt stored data. In the case of the DPE's implementation, a malicious computer program may be injected into the computing environment 308 where it may steal the algorithm 309 or the dataset 310.

Management of keys: At first glance, it may be thought that we can protect algorithm 309 and dataset 310 by encrypting and transmitting them to the computing environment 308 in encrypted form. Next, we may then provide a decryption key to the computing environment 308 when the decryption step is needed. However, such decryption keys may be accessed by malicious programs snooping in the computing environment 308. We also need to ensure that the mechanism by which the decryption keys are transmitted to the computing environment is secure and that the key requesting party and the key providing party are authorized since a malicious entity may “spoof” or “phish” these parties. Thus, key management itself becomes a problem needing to be solved.

Trust of Policy Manager: The Policy Manager 313 in the DPE constructs a policy and transmits certain elements of it to the computing environment 308. How can computing environment 308 trust the received policy elements since the received policy elements may incorrectly or maliciously direct the output of the computation to an unauthorized Output Recipient. Not only do we need to trust the policy in a policy directed computation, but we need to trust the source code of the Policy Manager 313 and the source code of the computing environment 308 since both 308 and 313 may be malicious or may be spoofed by malicious actors.

Trust in audit log: A malicious entity in control of the audit log may alter the records of the log.

Trust in algorithm's alleged execution producing output: The Output Recipient is provided an output allegedly produced by an algorithm operating on a certain dataset. How can the Output Recipient trust the provided output? Also, can the Algorithm Provider be assured that his/her algorithm was executed. If the output recipient is a patient and the provided output pertains to the diagnosis of a disease or recommends a therapy, how can the patient trust that the output was produced by an authorized and unaltered algorithm and that the algorithm was operating (or was trained) on authentic datasets?

In summary, the above problems point to the shortcomings in the implementation of a DPE that need to be addressed.

Background Technologies

To describe solutions to the problems enunciated above, it is instructive to consider some background technologies as detailed below.

Note on Public/Private Key Mechanisms: A public private key system comprises a pair of complementary functions encrypt and decrypt such that the former function (also known as the public key) can be used to encrypt data in such a fashion that it can only be decrypted by using the latter function (also known as the private or secret key). For example, user Bob may give his public key to user Alice and keep the secret key for himself User Alice uses Bob's public key to encrypt data that she wishes to send to Bob. Upon receipt, Bob uses his private key to decrypt the received data. For details, see Rivest, R., Shamir, A., Adleman, L. “A Method for Obtaining Digital Signatures and Public-Key Cryptosystems.” C. ACM 21(2), 1978. Also see the reference for O. Goldreich cited below.

As an example of the use of public key cryptography as enabling technology in the present invention, consider a policy that is to be provided to a computing environment (cf. 308, FIG. 3) by Algorithm Provider 301. To safeguard its ownership of the algorithm, Provider 301 may request the Policy Manager 313 to generate a pair of Public/Secret keys and provide it the Public key, which it uses to encrypt its algorithm. As mentioned above, the encrypted algorithm can only be decrypted by using the corresponding Secret Key which the Policy Manager keeps to itself and does not share either with the Operator or the data provider.

The encrypted algorithm may now be provided upon request to the computing environment 308. Since the algorithm is encrypted, it needs to be decrypted. Environment 308 requests the Policy Manager 313 for the corresponding secret key. The latter provides the secret key only by ensuring that the requesting party is trusted, a process that is detailed later. Thus, the ownership of the algorithm may be protected.

It is to be noted that the secret key remains in possession of the Policy Manager and is provided (using secure transport technologies such as Transport Layer Security—TLS) only to trusted environments. No actor receives the secret key. Thus, if the computing environments are isolated (a condition we describe below) or trusted (also described later), we can claim that the secret key is protected.

FIG. 5 depicts a method by which an algorithm is protected.

### Method: Protect Algorithm

1. Algorithm Provider requests Policy Manager to generate a secret/public key pair.
2. Policy Manager sends public key to Algorithm Provider.
3. Algorithm Provider encrypts algorithm using the received public key.
4. Algorithm Provider transmits the encrypted algorithm (upon request) to computing environment.
5. Computing environment requests corresponding secret key from Policy Manager.
6. Policy Manager ensures requesting environment can be trusted (using a method described later).
7. If the requesting environment can be trusted, the secret key is provided to the requesting environment; else the method fails.
8. Computing environment decrypts the algorithm using the provided secret key.

Similarly, the data provider may also request the Policy Manager to generate a (different) pair of Public/Secret keys, obtain the public key which it may use for encrypting its dataset before providing it to the computing environment 308. The latter then obtains the corresponding secret key from the Policy Manager to decrypt the data so it may be processed.

Cryptographic Hash Functions and Digests: A cryptographic hash function is a function or an algorithm that takes an arbitrary sized input (often called the message) and produces a per-determined fixed sized output (called the digest). It is a one-way function in the sense that it is computationally exorbitant to infer/derive the input from the output. (Only brute force algorithms are known to attempt to break the one-way property of well-known hash functions such as SHA-256, etc.) Hash functions are usually required to be deterministic in that the same message input produces the same digest and that two different inputs do not produce the same output, i.e., the no collision property. For further details, see O. Goldreich: Foundations of Cryptography, Vol. 1 & II, Cambridge University Press, 2001 & 2004.

We may use (cryptographic) hash functions to create technology that can be used to create computing environments that can be trusted. One way to achieve trust in a computing environment is by allowing the code running in an environment to be verified as follows.

We refer to this process of achieving trust as attestation. It provides a way to ensure that the code used to create a computing environment can be compared to a known and trusted copy of the code, i.e., a baseline, that is stored in an escrow service or is available in a publicly known location. If the comparison is successful, then the code creating a computing environment can be trusted. Furthermore, if the computing environment at any instant of time contains only code that can be attested and no other code is present in the computing environment (a condition we refer to as isolation and describe later), then it can be asserted that the computing environment can be trusted since it does not contain any unknown code and was created by code whose provenance is known and verified.

Consider a computer whose boot logic, i.e., logic that the computer executes when it is first powered on, is configured to create computing environments. Note that boot logic is typically considered as a part of the supervisory programs of computers. Further, assume that the supervisory programs of the computer contain a known hash function such as SHA-256. During the boot process, the supervisory programs execute an attestation process as follows.

The attestation process may be implemented as a combination of hardware, software and/or firmware. In some computers a so-called attestation module is dedicated to providing the attestation service.

A computing environment is created by the supervisory programs which are invoked by commands in the boot logic of a computer at boot time which then use the hash function, e.g., SHA-256, to take a digest of the created computing environment. This digest may then be provided to an escrow service to be used as a baseline for future comparisons.

FIG. 6 shows an arrangement by which a computing environment 602 created in computer 605 can be trusted using the attestation module 606 and supervisory programs 604.

FIG. 7 shows the method for trusting the computing environment 602.
Method: Attest a computing environment
Input: Supervisory program 604 of a computer 605 provisioned with attestation module 606, installation script 601.
Output: “Yes” if computing environment 602 can be trusted, otherwise “No.”
   1. Provisioning step: Boot the computer. Boot logic is configured to invoke attestation method. Digest is obtained and stored at escrow service as “baseline digest.”
   2. Initiate installation script which requests supervisory programs to create computing environment.
   3. Logic of computing environment requests Attestation Module to obtain a digest D of the created computing environment.
   4. Logic of computing environment requests escrow service to compare the digest D against the baseline digest.
   5. Escrow service reports “Yes” or “No” accordingly to the logic of the computing environment which, in turn, informs the installation script.

Note that the installation script is an application level computer program. Any application program may request the supervisory programs to create a computing environment which then use the above method to verify if the created environment can be trusted. Boot logic of the computer may also be configured, as described above, to request the supervisory programs to create a computing environment.

Whereas the above process can be used to trust computing environment created on a computer, we may in certain cases require that the underlying computer must be trusted as well. That is, can we trust that the computer was booted securely and that its state at any given time as presented by the contents of its internal memory registers can be trusted.

The attestation method may be further enhanced to read the various PCRs (Platform Configuration Registers) and take a digest of their contents. In practice, we may concatenate the digest obtained from the PCRs with that obtained from a computing environment and use that as a baseline for ensuring trust. In such cases, the attestation process which has been upgraded to include PCR attestation may be referred to as a measurement. Accordingly, in the examples presented below, all references to obtaining a digest of a computing environment are intended to refer to obtaining a measurement of the computing environment in alternative embodiments.

Note that a successful measurement of a computer implies that the underlying supervisory program has been securely booted and its state and that of the computer as represented by data in the various PCR registers is the same as the original state, which is assumed to be valid since we may assume that the underlying computer(s) are free of intrusion at time of manufacturing. Different manufacturers provide facilities that can be utilized by the Attestation Module to access the PCR registers. For example, some manufactures provide a hardware module called TPM (Trusted Platform Module) that can be queried to obtain data from PCR registers.

Key Vault: Key vault is a software service/technology typically built using hardware called a Hardware Security Module (HSM) that securely stores consumer secrets. A secret can be any piece of data provided by a consumer, e.g., keys, credentials, access passwords, certificates, etc. To retrieve a stored secret, a consumer needs to first be authenticated. Several cloud service providers provide key vault services, e.g., Microsoft Azure, Google Cloud Platform, etc.

As an example of the use of key vault systems as enabling technology, consider the descriptions above wherein a first actor needs to authenticate itself to a second actor. In such cases, a first actor may authenticate itself to the key vault, obtain a set of credentials and use them accordingly to authenticate itself to the second actor.

Isolated Computing Environments: Many existing computer systems provide facilities for memory elements to be isolated, i.e., only one or more authorized (system and application) processes may be executing concurrently in a memory segment. (The risk is that a concurrently executing process may access another process' memory and steal data.) As mentioned earlier, there are two types of processes: system and application processes. System processes are allowed access to an isolated memory segment if they provide the necessary keys. For example, Intel Software Guard Extension (SGX) technology uses hardware/firmware assistance to provide the necessary keys. Application processes also allowed entry to an isolated memory segment based on keys controlled by hardware/firmware/software element called the Access Control Module, ACM (described later).

Typically, system processes needed to create a computing environment are known a priori to the supervisory program and can be configured to ask and be permitted to access isolated memory segments. Only these specific system processes can then be allowed to run in an isolated memory segment. In the case of application processes such knowledge may not be known a priori. In this case, developers may be allowed to specify the keys that an application process needs to gain entry to a memory segment. Additionally, a maximum number of application processes may be specified that can be allowed concurrent access to an isolated memory segment.

Computing environments are created by code/logic available to supervisory programs of a computer cluster. This code may control which specific system processes are allowed to run in an isolated memory segment. Access control of application processes is maintained by another hardware/firmware/software module called the Access Control Module that is discussed later.

A computing environment created using isolated memory segments may be referred to as an isolated computing environment. More generally, an isolated computing environment is any computing environment in which a specified maximum number of application processes and specified system processes implementing the computing environment are able to operate.

It is important to highlight the difference between trusted and isolated computing environments. An isolated computing environment is an environment that supports a fixed or maximum number of application processes and specified system processes. A trusted computing environment is an environment in which the digest of the code running in the environment has been verified against a baseline digest.

As an example of the use of isolated memory as enabling technology, consider the creation of a computing environment as discussed above. The computing environment needs to be configured to permit a maximum number of (application) processes for concurrent execution. To satisfy this requirement, SGX or SEV technologies can be used to enforce isolation. For example, in the Intel SGX technology, a hardware module holds cryptographic keys that are used to control access by system processes to the isolated memory. Any application process requesting access to the isolated memory is required to present the keys needed by the Access Control Module. In SEV and other such environments, the supervisory program locks down the isolated memory and allows only a fixed or maximum number of application processes to execute concurrently.

Consider a computer with an operating system that can support multiple virtual machines (VMs). (An example of such an operating system is known as the Hypervisor or Virtual Machine Monitor, VMM.) The hypervisor allows one VM at a given instant to be resident in memory and have access to the processor(s) of the computer. Working as in conventional time sharing, VMs are swapped in and out, thus achieving temporal isolation.

Therefore, to achieve an isolated environment, we need a hypervisor like operating system to temporally isolate the VMs and, further, allow only specific system and a known (or maximum) number of application processes to run in a given VM.

Discerning readers would have noticed that whereas the method of FIG. 7 can be used to trust the code that creates computing environments, it cannot be used to trust the output of the algorithm producing results in a policy directed computation. This is because the digest only pertains to the code that creates the computing environment and not the algorithm that runs in said environment. It is possible that algorithm 309 (FIG. 3) could have been corrupted in transit or while stored. It is also possible that a malicious entity, e.g., operator, may have manipulated the policy in the Policy Manager 313. The question arises, how can an Output Recipient be assured that it was what he/she knows as algorithm 309 was executed and the output being provided to him/her is indeed the output of that algorithm? That is, various actors such as the output recipient or the algorithm provider may require proof of the alleged execution of the algorithm on specific data.

One possible method to solve this problem is to ask the Algorithm Provider to obtain a first digest of the (unencrypted) algorithm 309, possibly providing it to an escrow service as a baseline digest of the algorithm. Next, when algorithm 309 is provided to the computing environment 308 (and upon the subsequent decryption inside the computing environment), we obtain (by requesting the supervisory programs) a second digest and provide it to the escrow service for a comparison with the first digest. In this manner, we can establish that the algorithm executing inside the computing environment is the one that was provided by the algorithm provider.

Note that the above method requires support from the supervisory programs because they are being requested to obtain a digest not of the entire computing environment but of the segment of the environment that contains the algorithm. This necessitates a change in the logic of the supervisory programs, and we will need to rely on the providers of such programs to support this new functionality.

One way to avoid relying on support from supervisory program providers is to implement a new application level computer program called a digest generating engine (DGE) as follows.

FIG. 14 shows the architecture of a DGE. DGE is a computer program that contains (1) a well-known hash function such as SHA-256 as a first subroutine, and (2) an arbitrary algorithm, say A1 (configured to accept input “x”), as a second subroutine.

DGE operates by first running its first subroutine, i.e., hash function, SHA-256, on algorithm A1 as input and obtaining a digest as described above as output. DGE outputs the digest as its output, say “Digest.”

Next, it runs the second subroutine, i.e., the embedded algorithm A1 on input data “x” and outputs the output of the algorithm as say, “O.”

Thus, DGE has two outputs one from each of its two subroutines, i.e., the digest of the algorithm embedded in DGE and the output of the algorithm on its input data.

We now propose that the algorithm provider 301 (FIG. 3) may provide its algorithm embedded within DGE to the Policy Manager. We may use the notation that DGE contains algorithm A1 as DGE(A1). It is important to note that as far as a computing environment to which DGE is provided is concerned, DGE(A1) is a single algorithm.

When a computing environment launches a DGE as described herein as per a policy directed computation, the resulting output is a digest of the algorithm A1 and the intended output of the policy directed computation, i.e., the output resulting from the execution of the algorithm A1 on its input data “x.” Hence, we may use the outputted digest to compare it against the saved baseline digest of the algorithm A1 to gain as assurance that the output of a policy directed computation used the intended algorithm.

We refer to computing environments that allow their algorithmic execution to be verified as verified computing environments.

(In embodiments, the DGE may be configured to produce additional outputs other than the two types of outputs described above. For example, the DGE may be configured to scan the software libraries included in the algorithm for malware. Many enterprises offer such scanning services, e.g., Symantec, Redhat, and the National Institute of Standards and Technology. In such embodiments, the DGE may be configured to produce an additional output certifying that the libraries used by the algorithm are free of malware.)

The discussions above have allowed us to formulate the following three notions.
1. Trusted computing environments are environments which are created using logic that has been verified with reference to a baseline digest.
2. Isolated computing environments are those that allow only specific system processes and a maximum number of application processes to execute concurrently within them.
3. Verified computing environments are those that provide a verification of the algorithm running inside them.

We say that a policy directed computation is secure if it is run in a trusted and isolated computing environment.

A policy driven computation is said to maintain user data privacy if the input dataset is first filtered using differential privacy (cf. C. Dwork, Differential Privacy: A survey of results, in Theory and Applications of Models of Computation, Lecture Notes in Computer Science, Springer Berlin Heidelberg. pp. 1-19, ISBN 9783540792277) or by de-anonymizing the input dataset.

We observe that the notion of a trusted environment relies on trust in the Policy Manager since the latter provides policies and decryption keys to other computing environments. A malicious Policy Manager or one whose code has been compromised cannot assure trust in computing environments serviced by it.

Therefore, we propose that the Policy Manager also runs in a trusted and isolated environment whose integrity is guaranteed by the underlying attestation module. Again, we may use an escrow service or a publicly known publishing location to store the baseline digest of the Policy Manager's code and platform PCR data, as in the case of the policy directed computation environment.

Thus, in essence, both the Policy Manager and the policy directed computations run in trusted environments that are attested to be valid.

### Implementing Secure Policy Directed Computations

We now present an implementation in which the various encryption and other technologies discussed above are used to create computing environments to achieve secure policy directed computations.

We begin by adding components or elements to the DPE of FIG. 3 as shown in FIG. 8 to establish a TDPE. The newly added elements are as follows.
Admission Control Module (ACM) 805, 890: The ACM is a hardware/software/firmware element that uses cryptographic keys to control access to a computing environment. As explained above, some of the cryptographic keys may be contained in hardware elements at the time of manufacturing and provisioned in firmware/software; other keys may be provided to the ACM by application programs.
The computing environment 308 of FIG. 3 is replaced by a computing environment 808 that can be trusted using the method of FIG. 7. Additionally, a computer cluster is provisioned on which an isolated computing environment can be created, thereby guaranteeing the integrity of the computations occurring within the computing environment. Thus, to achieve trust and isolation, the underlying computer cluster 840 needs to contain the Attestation System 813, the Platform System 814 and the Key Vault 815 as they are used to generate the measurement and attestation digests as described above, all of which are accessible by the supervisory program 812. Whereas FIG. 8 shows an illustrative embodiment using two computer clusters 840 and 860, in other embodiments a single computer cluster may suffice in which all the components or elements depicted in computer clusters 840 and 860 are implemented.
Algorithm 809 is encapsulated within program DGE 870 as discussed above so that the output of the algorithm can be verified.
The Policy Manager 817 and the audit manager (not shown in FIG. 8 for reasons of simplicity) are encapsulated within a DGE 880, which in turn is contained in a secure environment 850 established within computer cluster 860. The supervisory program and the attestation manager, key vault, installation script, and platform system for computer cluster 860 are not shown in FIG. 8 but are assumed to exist. They serve similar functions as in computer cluster 840.
Network connections between the Data Provider, Algorithm Provider, Output Data Store and computer clusters 840 and 860 are not shown. These computer programs, which will generally reside on different computers, may communicate over any suitable combination of one or more communication networks, including but not limited to wide-area-networks (e.g., public and/or private internets), local-area-networks, and wired and wireless networks.

Note that in FIG. 8 we show the data 810 as being available in explicit form to algorithm 809 embedded in the DGE 870. As is known to practitioners of the art, the data may be stored in an external database and provided to algorithm 809 by using a data processing program which retrieves data from the external database as and when needed. This is shown in FIG. 13. In FIG. 13-A, we show the explicit form in which data 1310 is available to algorithm 1309. In FIG. 13-B we show the use of a data processing program 1311 to provide data to the algorithm 1309 by retrieving it from the external database 1320. Note that in the latter case, ACM 805 (FIG. 8) will need to allow the database application to return data requested from the database 1320. That is, two application processes may be used in secure environment 1308, one managing the algorithm and the other managing the database requests.

It is to be noted that the ACM 805 (FIG. 8) may be used to allow computing environments to be accessed only by pre-determined applications, e.g., those that are provided with specific keys. Therefore, the supervisory programs may be excluded from accessing a computing environment. For example, the supervisory programs when invoked to create a computing environment may be provided a public key which they store in the ACM. The ACM's logic may then require that the corresponding secret key be provided before the ACM allows entry to the created computing environment. Note that the supervisory programs may only be provided the public key and not the corresponding secret key. Thus, the supervisory programs may be asked (by an application) to create a computing environment using a public key whose corresponding secret key is not known to the supervisory programs. In this manner, the supervisory programs may create a computing environment that is inaccessible to them.

In the descriptions below, the computing environments 808 and 850 (FIG. 8) are environments that are created by the supervisory programs but whose contents are not accessible to the latter, i.e., the supervisory programs. (Note that environment 808 will be created by an installation script triggered by the Operator; environment 850 will be created by installation script 806 triggered by Policy Manager 817.) Access to environment 850 is controlled by the Operator using public keys whose corresponding secret keys are in his/her possession and not available to the supervisory programs of computer cluster 860. Access to environment 808 is controlled by secret keys known to Policy Manager 817 executing in environment 850 and are not known to the supervisory programs of computer cluster 840.

FIG. 9 shows one example of a method by which a secure policy directed computation is performed using the TDPE shown in FIG. 8.

In step 1, we assume the following sub-steps have been accomplished.
(a) The Policy Manager is a computer program produced by an enterprise. We assume that the enterprise provides a digest of the code of the Policy Manager to serve as a baseline to an escrow service.
(b) Operator provisions a computer cluster 860 capable of creating isolated computing environments and installs an installation script (not shown in FIG. 8) on it. The Operator generates a secret/public key pair and provides the public key to the installation script that requests supervisory programs to create an isolated computing environment 850 using that public key. (Operator saves the secret key for himself/herself.) Logic of environment 850 uses the method of FIG. 7 to ensure that environment 850 is a trusted environment. The computing environment 850 is configured to load the Policy Manager 817, which is encapsulated in a DGE 880.
   (Note that although the Operator can, in principle, access the computing environment 850 since it has the secret key needed to allow admission, it cannot make changes to the code/logic running in that environment, e.g., change the code to output a secret key, since any changes to the code will not match the baseline image of that environment stored with the escrow service, thereby causing subsequent attestations to fail.)

In step 2, the algorithm and data providers communicate information to the operator (e.g., via a web page interface). The provided information includes, inter alia, the name of the algorithm, the dataset, and the network addresses from where the same can be obtained. The Policy Manager 817 reads the information entered into the web portal and translates it into a policy data structure, P.

In step 3a, the Policy Manager 817 (FIG. 8) provisions a second computer cluster 840 capable of creating isolated computing environments and installs script 806 on it.

In step 3b, the Policy Manager 817 provides the network address of the Key Vault 815 on the newly provisioned computer cluster 840 to the Algorithm Provider 801. In step 3c the algorithm provider 801 asks the Key Vault 815 to create (1) an account, and (2) a secret/public key pair SK1/PK1. (By creating an account with Key Vault, the algorithm provider comes into possession of account credentials that allow it to gain authorized access to the key pair SK1/PK1.) In step 3d the secret/public key pair SK1/PK1 is provided to the algorithm provider. The Algorithm Provider 801 shares the public key PK1 with the Policy Manager 817 in step 3e. The Policy Manager 817 associates the PK1 with the policy P. Note that the secret key SK1 corresponding to PK1 is stored in the Key Vault 815 and is not available to the Policy Manager 817 since the latter does not possess the account credentials of the Algorithm Provider 801.

Similarly, in step 3f, the Policy Manager 817 provides the network address of the Key Vault 815 on the newly provisioned computer cluster 840 to the Data Provider 802. In step 3g the data provider 802 asks the Key Vault 815 to create (1) an account, and (2) a secret/public key pair SK2/PK2. (By creating an account with Key Vault, the data provider comes into possession of account credentials that allow it to gain authorized access to the key pair SK2/PK2.) In step 3h the secret/public key pair SK2/PK2 is provided to the data provider 802. The Data Provider shares PK2 with the Policy Manager 817 in step 3i. The Policy Manager 817 associates the received PK2 with the policy P.

The descriptions below now refer to FIG. 10.

In step 4, the Policy Manager 817 creates a secret/public key pair SK3/PK3 and provides the public key, PK3, to the installation script 806 along with the public keys PK1 and PK2 it had obtained from the Algorithm and Data providers in step 3e and 3h above, respectively. The installation script 806, in turn, issues a request (step 5) to Supervisory Programs 812 to initiate the creation of an isolated computing environment 808 using the public key PK3. The Policy Manager 817 associates SK3/PK3 with policy P. (Note that the underlying computer cluster 840 and its supervisory programs are assumed to provide capabilities to support an isolated environment.) Script 806 is provided the name of the policy in the Policy Manager that needs to be serviced by the secure environment 850. Various parameters controlling the creation of the secure environment may be provided by the installation script 806 as a part of the initiation request, e.g., network address of the Policy Manager, size of secure environment, name of policy to be serviced, public keys PK1, PK2 and PK3, etc.

In step 6, the Supervisory Programs 812 create isolated computing environment 808. In step 7, the supervisory programs request the Attestation Module 813 to take a measurement of secure environment 808 and gets it verified by the escrow service. Logic of the secure computing environment 808 informs the installation script 806 that secure computing environment 808 is an isolated and trusted computing environment which, in turn, informs the Policy Manager 817.

Note that at the conclusion of step 7, the Policy Manager 817 knows that secure computing environment 808 is a trusted and isolated, i.e., secure, environment. Furthermore, that ACM 805 is configured to control access to environment 808. In particular, the ACM 805 is configured to allow access to any party which has the secret keys corresponding to the public keys PK1, PK2, and PK3. Thus, the Algorithm Provider 801 may use its account credentials with the Key Vault 815 to obtain the secret key SK1 corresponding to PK1 and gain access to environment 808. Similarly, the Data Provider 802 can gain access by getting the secret key SK2 from the Key Vault using his account credentials. Finally, the Policy Manager 817 has the secret key SK3 corresponding to PK3 which it can use to gain access to 808.

In step 8, the secure computing environment 808 requests the Policy Manager 817 to send it, inter alia, the address of the algorithm and data providers associated with policy P.

In step 9, the Policy Manager 817 receives the request from secure environment 808. Recall that policy P is represented by a data structure some of whose elements, e.g., keys PK1, PK2, etc., are provided by the Algorithm and Data Providers in step 4 above, and other elements, e.g., SK3/PK3, etc., are generated by the Policy Manager itself. In embodiments, a protocol (not discussed in detail herein) may be used to control what elements can be requested from the Policy Manager 817 and which conditions are to be satisfied before such requests can be honored. For example, a Policy Manager may be requested to provide secret keys, and the protocol may specify that the Policy Manager is required to ensure that the requesting party is a trusted and isolated computing environment that was established by the Policy Manager itself before the request can be honored. The Policy Manager 817 having received the request in step 9, verifies that the pre-conditions imposed by the protocol have been met before it sends the requested policy, which includes the requested network addresses of the algorithm and data providers, to the secure environment 808.

The descriptions below now refer to FIG. 11.

In steps 10 & 11, logic of the secure environment 808 connects with the algorithm and data provider 801 and 802, respectively (whose addresses were obtained in step 9 above) and requests that the algorithm and data be provided to it. The algorithm and data provider access their accounts on the Key Vault to obtain the secret keys SK1 and SK2, respectively, and use them to encrypt the algorithm and the dataset. The encrypted data and algorithm are encapsulated in a DGE and provided to the secure environment 808. At the conclusion of this step, secure environment has the data and algorithm embedded in the DGE, i.e., DGE(A1), in encrypted form. Note that since the algorithm and data provider have SK1 and SK2 they are allowed access to the environment 808 by the ACM 805.

Next in steps 12 & 13, secure environment logic requests and receives SK1 and SK2 from the Algorithm and Data Provider 801 and 802, respectively. Since it has already been checked that environment 808 is secure, the algorithm and data providers send it SK1 and SK2. Secure environment logic decrypts the algorithm and data using the received keys (step 14) and launches an execution (step 15).

(In alternative embodiments, the secret keys SK1 and SK2 may be provided by the algorithm and data providers 801 and 802 to the Policy Manager 817. The environment 808 may then request the Policy Manager 817 for SK1 and SK2.)

Note that the algorithm launched in step 15 actually comprises of the DGE that, in turn, contains within it the algorithm provided by the algorithm provider 801 (FIG. 8). That is, the resulting execution of the DGE produces a digest and the output of the algorithm provided by 801.

In step 16, the output of the DGE, i.e., the digest, and the output of the algorithm provided by 801, are outputted to the output store 819. The output of the algorithm is outputted in encrypted form. In embodiments, the encryption key may be requested from the Policy Manager 817 in step 9 above whereupon the Policy Manager may generate an encryption key, send it to the computing environment 808, and also provide it to the Key Vault 815 for storage. (This step is not shown in FIGS. 10 & 11.)

In step 17, the Policy Manager 817 is informed that the policy directed computation has been completed. In step 18, the Policy Manager informs the output recipient of the availability of the output. The output recipient 804 retrieves the output from the output store 819 and authenticates himself/herself to the Key Vault 815, obtains the decryption key from the Key Vault, and uses it to decrypt the output.

We point out that in the above discussion we have used two types of key technologies. For example, the Policy Manager uses secret/public key cryptography to manage information elements of the policy P above. This is the first type of key technology.

The Key Vault 817 may use, inter alia, a second type of key technology called symmetric keys in which the same key is used both for encryption and decryption. Thus, for example, Alice and Bob both know and possess the same symmetric key. Alice may encrypt a message using her key and send the (encrypted) message to Bob who may then use his key to decrypt the message.

The use of secret/public key and symmetric key technologies is exemplary and more generally different types of encryption and decryptions keys may be employed in different configurations. Moreover, the manner in which the keys are provisioned and provided to the appropriate parties may differ from the particular implementation shown in FIGS. 9-11.

Note that the requirement that the output recipient is to be provided an encrypted output may be imposed by the Data or the Algorithm Provider. As such, it is the duty of the Policy Manager to enforce this requirement, which it does by constructing the policy data structure P accordingly in step 2 above.

Note further that the digest outputted by the DGE 870 in step 16 may be used to verify the provenance of the algorithm running in the secure environment 808.

In the above descriptions, we stated that application level programs, e.g., the installation script 806, may invoke the supervisory programs to ask for the creation of an (isolated) environment. The supervisory programs then request the Attestation Module to undertake a measurement or an attestation and then inform the application program that an isolated and trusted environment has been created. In certain use cases, this situation may be considered a possible weakness since a malicious program may pretend to be the installation script by, e.g., stealing the credentials of the installation script.

We can avoid this possible security loophole by ensuring that all applications (including the installation script) must be authorized, e.g., by using the Key Vault to authenticate the applications using stored credentials. As noted, the Key Vault is a hardware/software/firmware solution specifically designed to withstand malicious attacks.

We have not discussed the Audit Manager in the discussions above. We note that, in a manner similar to the Policy Manager, the Audit Manager 314 may also be housed in an isolated and trusted computing environment. Alternatively, other technologies, e.g., blockchain technology, may be used to maintain the log as an immutable data structure.

### Chain of Trusted Policy Driven Computations

FIG. 8 shows a TDPE that executes one policy driven computation. We can create a series of inter-connected policy driven computations (equivalently, a pipeline of connected TDPEs) by requesting a first protected environment to output an image of its state and connecting such an outputted image to a second protected environment, etc. The latter may now be provided a second dataset as input.

We consider a specifically designed algorithm, say A, that is configured as follows. At initialization, algorithm A reads into its internal memory a data structure, called the model, that assigns values to a set of variables. It may then read other input data and process it, possibly using its (acquired) model values. The processing may cause some of the model values to be altered. At completion, the algorithm outputs, inter alia, the possibly modified set of values corresponding to its model. If the algorithm is now run a second time, it will read the previously outputted model data values and proceed to process any other inputs in light of the newly acquired model data. Such algorithms are routinely used in the area of federated machine learning wherein the same algorithm is “trained” on a series of sequentially available datasets. As each dataset is processed by the algorithm, updates are made to the model values, resulting in the algorithm incrementally learning from the updating of its model values against the various input datasets.

FIG. 12 shows the modified arrangement based on FIG. 8 that can be achieved to implement federated machine learning using secure environments. Secure environment 1201 is provided dataset 1 and Algorithm A as input. Environment 1201 finishes the policy directed computation and outputs a result called “Model 1.”

Next, we provide model 1 and dataset 2 as input to secure environment 1202 along with the same algorithm as before, i.e., algorithm A. This results in the outputting of a new model, Model 2, etc.

Note that FIG. 12 does not show many of the elements shown in FIG. 8 for reasons of simplicity. Thus, a chain of trust can be extended to cover both protected environments 1201 and 1202.

### Technological Contributions of the Present Invention

The present invention provides arrangements and methods to enhance the integrity of computations (equivalently, processes) which are created by the operating system of and executed on a computer.

In one aspect the present invention enhances the integrity of computations by ensuring that no external entity may copy or steal the algorithm or the data, and that the outputs of computations are directed only to pre-specified recipients.

Furthermore, outputs generated by computations can be verified as having been the result of the execution of a specific algorithm operating on specific dataset(s). Thus, the provenance of the results can be ascertained.

We show how the technology by which supervisory programs such as operating systems create isolated environments that may be combined with the notion of trust as defined herein, thereby enhancing the notion of integrity of computer processes.

We show methods by which cryptographic data, needed to ensure integrity of processes is generated within and transmitted only between computational entities, e.g., computing environments, that can be verified to be free of malware and other intrusive software, i.e., concurrently executing processes, thereby preventing the theft of data, results, and algorithms. In this sense, the present invention enhances the run-time security of computers against malware and intrusive software, e.g., against trapdoors, trojan horses, etc.

In particular, we show how computing environments may be created by supervisory programs (of a computer cluster) that are themselves unable to access the contents of said computing environments. As cloud computing grows, such capabilities may be used in embodiments to assure enterprises of the integrity of the computations that they carry out on their “rented” cloud computing clusters. That is, an enterprise may rent a cluster of computers from a cloud provider and carry out computations on said cluster, safe in the knowledge that the supervisory programs of the rented computer cluster are unable to access the contents of said computations.

In another aspect, the invention supports computations that preserve user data privacy, e.g., HIPAA compliance, in the following sense. Datasets may be inputted to a computing environment in encrypted form. The dataset is then only decrypted within the confines of said computing environment, which is isolated, trusted and whose contents cannot be accessed by a non-trusted entity. Any output produced by the computing environment can be directed solely in encrypted form to a pre-specified recipient. The latter may be required to produce credentials that verify that the recipient is, e.g., HIPAA compliant, before it can receive outputted user data. Note that HIPAA regulations permit user data to be shared between HIPAA compliant enterprises.

### Illustrative Embodiments

We present several embodiments to show various features of the present invention without limiting the full scope of the invention.

Embodiment 1: Client devices such as smart phones are associated with one or more sensor devices (external or internal to the client device) using wireless or tethered connections. The client devices receive various kinds of data from the associated sensor devices, e.g., health-related data from an external fitness bracelet or a smart watch, location data from an internal GPS sensor, etc. Data from the client devices may be aggregated, combined and processed in a TDPE using third party algorithms. In one use case, consumers may be provided personalized health reports or advertisements resulting from the processing in the TDPE. Note that the security and trust associated with the TDPE assures both consumers and application developers. Health and activity data may also be collected from users to monitor them for side effects of drugs and medications. Users may be alerted of adverse conditions upon detection of the same.

Embodiment 2: A first enterprise makes available a first dataset to train an algorithm A. The resulting state of the TDPE is saved. Next, a second enterprise provides a second dataset to the saved state of the TDPE which incrementally processes the new dataset to create a new state of the TDPE. Note that in this embodiment the first and second datasets are not combined but are processed serially by the same example. Thus, algorithm A undergoes a process of incremental training using datasets from different providers.

Embodiment 3: The state of a multiplayer game may be captured in a TDPE and controlled by the game logic running in the TDPE. The TDPE's algorithms may be configured to assign virtual identifiers for each player that cannot be faked by the players. Furthermore, the state of the game cannot be altered by any player or external entity since the TDPE is secure and trusted.

A dataset may also be processed in a TDPE by an advertiser to determine potential recipients of advertisements. Virtual identifiers may then be used to direct advertisements to such consumers.

### Illustrative Computing Environment

As discussed above, aspects of the subject matter described herein may be described in the general context of computer-executable instructions, such as computer programs, being executed by a computer or a cluster of computers. Generally, computer programs include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Also, it is noted that some embodiments have been described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

The claimed subject matter may be implemented as a method, apparatus, or article of manufacture using standard programming and/or engineering techniques to produce software, firmware, hardware, or any combination thereof to control a computer to implement the disclosed subject matter. For instance, the claimed subject matter may be implemented as a computer-readable storage medium embedded with a computer executable program, which encompasses a computer program accessible from any computer-readable storage device or storage media. For example, computer readable storage media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). However, computer readable storage media do not include transitory forms of storage such as propagating signals, for example. Of course, those skilled in the art will recognize many modifications may be made to this configuration without departing from the scope or spirit of the claimed subject matter.

As used herein the terms “software,” computer programs,” “programs,” “computer code” and the like refer to a set of program instructions running on an arithmetical processing device such as a microprocessor or DSP chip, or as a set of logic operations implemented in circuitry such as a field-programmable gate array (FPGA) or in a semicustom or custom VLSI integrated circuit. That is, all such references to “software,” computer programs,” “programs,” “computer code,” as well as references to various “engines” and the like may be implemented in any form of logic embodied in hardware, a combination of hardware and software, software, or software in execution. Furthermore, logic embodied, for instance, exclusively in hardware may also be arranged in some embodiments to function as its own trusted execution environment.

Moreover, as used in this application, the terms “component,” “module,” “engine,” “system,” “apparatus,” “interface,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediary components. Likewise, any two components so associated can also be viewed as being “operably connected”, or “operably coupled”, to each other to achieve the desired functionality.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments.

1. A method for maintaining the integrity of a data processing system, comprising:
creating a policy data structure containing at least one policy based at least in part on information provided by an algorithm provider and a data provider, the algorithm provider providing at least one algorithm that is to be executed on at least one dataset provided by the data provider, the policy data structure being created by policy manager logic operating in a first trusted and isolated computing environment, wherein a trusted computing environment is a computing environment whose computer code is able to be attested by comparing a digest of computing environment to a baseline digest of the computing environment that is available to third parties to thereby verify computing environment integrity, an isolated computing environment being a computing environment in which only a specified maximum number of application processes and specified system processes implementing the computing environment are able to operate;
causing, by the policy manager logic, creation of a second trusted and isolated computing environment;
responsive to a request from the second computing environment, sending the policy data structure to the second computing environment;
in accordance with the policy, receiving in the second computing environment in an encrypted form the algorithm and the dataset from the algorithm provider and the data provider, respectively;
in accordance with the policy, obtaining one or more decryption keys for decrypting the encrypted algorithm and the encrypted dataset and decrypting the encrypted algorithm and the encrypted dataset;
causing the decrypted algorithm and the decrypted dataset to be input into a digest generating environment (DGE) operating in the second computing environment, the DGE being configured to provide a digest of the decrypted algorithm and an algorithm output from executing the decrypted algorithm on the decrypted dataset; and
in accordance with the policy, encrypting the digest of the decrypted algorithm and an algorithm output arising from execution of the decrypted algorithm on the decrypted dataset in the DGE and sending the encrypted digest and the encrypted algorithm output from the second computing environment to an output data store specified by the policy.

2. The method of claim 1, wherein the one or more decryption keys for decrypting the encrypted algorithm and the encrypted dataset are obtained from the policy manager logic or the algorithm provider and the dataset provider, respectively.

3. The method of claim 1, wherein encrypting the digest of the encrypted algorithm and the algorithm output arising from execution of the decrypted algorithm on the decrypted dataset is performed using an encryption key obtained from the policy manager logic.

4. The method of claim 3, further comprising storing the key encrypting the digest of the encrypted algorithm and the algorithm output in a hardware security module included in a hardware computing arrangement in which the second computing environment is created.

5. The method of claim 1, wherein the computing environment is created in a hardware computing arrangement that includes a plurality of computing machines.

6. The method of claim 1, wherein the encryption keys encrypting the algorithm and the dataset are provided to the algorithm provider and the dataset provider by a key vault associated with the second trusted and isolated computing environment in response to receipt of pre-established account credentials from the algorithm provider and the dataset provider.

7. The method of claim 1, wherein creation of the second trusted and isolated computing environment includes creating an isolated computing environment in isolated memory using supervisory programs that are provided with a public access key of a public-private access key pair and not the private key of the public-private access key pair such that access to the computing environment is unavailable to the supervisory programs to thereby prevent the supervisory programs from affecting results of computations executed in the computing environment.

8. The method of claim 7, wherein the public access key is provided to the supervisory programs by the policy manager logic.

9. The method of claim 3, wherein the policy manager logic provides a decryption key for decrypting the encrypted algorithm output to a designated recipient after the designated recipient is authorized using pre-established account credentials.

10. A method for providing a secure computing environment, comprising:
creating an isolated computing environment using supervisory programs that are provided with a public access key of a public-private access key pair and not the private key of the public-private access key pair such that access to the computing environment is unavailable to the supervisory programs to thereby prevent the supervisory programs from affecting results of computations executed in the computing environment, wherein an isolated computing environment is a computing environment in which only a specified maximum number of application processes and specified system processes implementing the computing environment are able to operate; and
causing a baseline digest of the isolated computing environment to be generated and stored in a location so that the baseline digest is validated by or available to at least one third party to thereby establish a trusted and isolated computing environment.

11. The method of claim 10, wherein policy manager logic causes creation of the isolated and trusted computing environment, the policy manager logic providing a policy data structure to the isolated and trusted computing environment, the algorithm provider providing at least one algorithm that is to be executed on at least one dataset provided by the data provider, the policy data structure specifying one or more policies concerning processes to be followed and/or parameters to be used to execute the algorithm on the at least one dataset in the isolated and trusted computing environment.

12. The method of claim 11, wherein the one or more policies are based at least in part on information provided by the algorithm provider and the data provider

13. The method of claim 11, wherein the one or more policies specify that the algorithm and the dataset are to be provided access to the isolated and trusted computing environment and further comprising receiving in the isolated and trusted computing environment the algorithm and the dataset in encrypted form.

14. The method of claim 13, wherein the algorithm provider and the dataset provider encrypt the algorithm and the dataset, respectively, using a private key that is provided by a key vault associated with the isolated and trusted computing environment in response to receipt of pre-established account credentials from the algorithm provider and the dataset provider.

15. The method of claim 14, further comprising, in accordance with the one or more policies, obtaining one or more decryption keys for decrypting the encrypted algorithm and the encrypted dataset and decrypting the encrypted algorithm and the encrypted dataset.

16. The method of claim 15, wherein the encryption keys are provided by a key vault associated with the trusted and isolated computing environment in response to receipt of pre-established account credentials from the algorithm provider and the dataset provider.

17. The method of claim 15, wherein the private keys that encrypt the algorithm and the dataset are used as the decryption keys.

18. The method of claim 15, further comprising causing the decrypted algorithm and the decrypted dataset to be input into a digest generating environment (DGE) operating in the computing environment, the DGE being configured to provide a digest of the decrypted algorithm and an algorithm output from executing the decrypted algorithm on the decrypted dataset.

19. The method of claim 11, further comprising, in accordance with the one or more policies, encrypting the digest of the decrypted algorithm and an algorithm output arising from execution of the decrypted algorithm on the decrypted dataset in the DGE and sending the encrypted digest and the encrypted algorithm output from the second computing environment to an output data store specified by the policy.

20. The method of claim 19, wherein the digest of the decrypted algorithm and the algorithm output are encrypted using an encryption key provided by the policy manager logic.

21. The method of claim 20, wherein the policy manager logic provides a decryption key for decrypting the encrypted algorithm output to a designated recipient after the designated recipient is authorized using pre-established account credentials.

22. The method of claim 10, wherein creating the isolated computing environment includes creating the isolated computing environment in isolated memory.
